(19) United States
(12) Patent Application Publication
(10) Pub. No.: US 2006/0042155 A1
(43) Pub. Date: Mar. 2, 2006

(54) Use of nitrogen dioxide (NO2) for insect attraction

(76) Inventor: James A. Nolen, West Greenwich, RI (US)

Correspondence Address: Norma E. Henderson;Hinckley, Allen & Snyder LLP, 2nd floor, 43 North Main Street, Concord, NH, 03301-4934, US

(21) Appl. No.: 11/185,586

(22) Filed: Jul. 20, 2005

Related U.S. Application Data
(63) Continuation-in-part of application No. 10/723,421, filed on Nov. 26, 2003, now abandoned.
(60) Provisional application No. 60/430,323, filed on Dec. 2, 2002.

(51) Int. Cl. A01M 1/22; A01M 1/02; A01M 1/06

(52) U.S. Cl. 43/112; 43/107; 43/139

(57) ABSTRACT

Nitrogen dioxide is an effective insect attractant that can be employed in a variety of traps and forms, both alone and in combination with other attractants, and particularly is an effective attractant enhancer when used in combination with other attractants such as carbon dioxide, Octenol, heat, and/or light. In one embodiment, NO₂ is produced by a device that generates the gas through electrical means, such as an ozone-generator device that employs an ozone-producing unit, contacting ozone produced in the unit with activated carbon, thereby producing an insect-attracting gas containing at least nitrogen dioxide that can be fed to an insect trap. The ozone generator may be employed alone or in combination with a supplemental source of CO₂ or other attractant. In another embodiment, a mix of CO₂, or other attractant, and NO₂ from bottles is used in a trap designed for use with pressurized gas canisters. In yet another embodiment, an NO₂ generator or a small bottle of NO₂ is retrofitted to a CO₂-generating propane mosquito trap.

### RELATED APPLICATIONS

This application is a continuation-in-part of U.S. patent application Ser. No. 10/723,421, filed Nov. 26, 2003, which claims the benefit of U.S. Provisional Patent Application No. 60/430,323, filed Dec. 2, 2002, both of which are herein incorporated by reference in their entirety.

### FIELD OF THE INVENTION

The invention relates to providing a gaseous product for attracting insects and, in particular, to use of nitrogen dioxide for insect attraction and to enhance the effectiveness of other insect-attracting gases.

### BACKGROUND

Devices for attracting and destroying insects are well known in the art. These prior art devices employ a number of mechanisms and materials to attract insects such as, for example, heat, light, odor emitting substances, pheromones, kairomones, and various chemicals. Researchers in the field of entomology have discovered that biting insects such as midges, biting flies, and mosquitoes are attracted to blood hosts by the odor of kairomones, which are chemicals given off by the blood host and act as attractants to such biting insects. For example, such kairomones include carbon dioxide, exhaled by both avian and mammalian blood host, and octenol, an alcohol that is given off by mammalian blood hosts. It has been shown that mosquitoes and biting flies can detect the odor of carbon dioxide given off by a blood host at a distance of approximately 90 meters [“The Tsetse (Diptera: Glossinidae) Story: Implications for Mosquitoes”, S J Torr, JAMA 10(2):258-265, 1994 (“Studies using electric nets placed at various distances downwind of a host show that a plume of odor from a single ox elicits upwind flight 90 m downwind of the source (Vale 1977 a)”)]. Biting insects locate a blood host by tracking the carbon dioxide plume created by a blood host. It has been discovered that a mixture of carbon dioxide and octenol is especially attractive to insects seeking mammalian blood hosts. Examples of devices employing carbon dioxide and Octenol are, for example, disclosed in U.S. Pat. Nos. 5,205,064 and 6,055,766.

### SUMMARY

In a preferred embodiment of the method of the present invention, NO₂ is used as an attractant enhancer in conjunction with CO₂. NO₂ may also be used to enhance other attractants, alone or in combination, such as Octenol, thermal or light lures, or any other insect attractant known in the art. There are several preferred embodiments of the apparatus of the present invention. In one embodiment, NO₂ is produced by a device that generates the gas through electrical means, such as through an ozone-generator device. The NO₂ generator of this embodiment may be employed alone or in combination with a supplemental source of CO₂ or other attractant supplied from bottles or generated. In another embodiment, a mix of NO₂ and CO₂ from bottles, with or without other attractants, is provided for use in a trap designed for use with pressurized gas canisters. In yet another embodiment, an NO₂ generator or a small bottle of NO₂ is retrofitted to a CO₂-generating propane mosquito trap, with or without other attractants.

The present invention demonstrates that the inclusion of very small amounts of NO₂, on the order of 200 ppb or less, enhances the effectiveness of CO₂ or other attractants as much as ten-fold. One of the primary advantages of this invention is that it permits use of greatly reduced levels of the other attractants, thereby greatly increasing the intervals between necessary replenishment of those attractants in a trap and concomitantly decreasing the costs associated with the purchase and replenishment ofthose attractants. While the preferred embodiment of the present invention employs NO₂ as an attractant enhancer, it has also been shown that NO₂ alone acts as an attractant for at least some species.

### BRIEF DESCRIPTION OF THE DRAWINGS

The invention is illustrated, but not limited by, the embodiments shown in the accompanying drawings in which:

FIG. 1 is a side view of an NO₂-producing device useful in one embodiment of the present invention;

FIG. 2 is a side view of the device of FIG. 1 with the side panel of the device removed;

FIG. 3 is a cross sectional view of the device along line 3-3 of FIG. 2;

FIG. 4 is a side view of the device of FIG. 1 attached to an insect attracting/destroying element;

FIG. 5 is a chart showing the results of field trials using a trap employing the device of FIGS. 1-4 to produce NO₂ as an insect attractant according to an embodiment of the present invention;

FIG. 6 is a graph showing the laboratory-tested gas output of the device used in the field trials of FIG. 5;

FIG. 7A is an insect-attracting device using NO₂ as an insect attractant enhancer according to an embodiment of the present invention;

FIG. 7B is a detail view of part of the device of FIG. 7A; and

FIG. 8 is a chart showing the results of field trials using NO₂ as an insect attractant enhancer in the device of FIGS. 7A and 7B according to an embodiment of the present invention.

### DETAILED DESCRIPTION

Blood seeking insects, particularly mosquitoes, have been shown to have carbon dioxide receptors around the base of their antennae. Normally, about 50 cc/min carbon dioxide, which binds to the insects' receptors, is required to elicit host-seeking behavior in most species of biting flies, midges and mosquitoes. In the present invention, it has been discovered and demonstrated that the attractiveness of carbon dioxide and other insect attractants is greatly enhanced by the addition of nitrogen dioxide (NO₂). In the presence of the insect-attracting gaseous product containing NO₂ of this invention, much larger collections of insects have been achieved with less carbon dioxide than with carbon dioxide alone. Further, in the present invention it has been discovered and demonstrated that nitrogen dioxide alone has insect-attracting properties, whether generated by a canister, an ozone-generator apparatus, or any other method known in the art.

In the preferred embodiment of the method of the present invention, NO₂ is used as an attractant enhancer in conjunction with CO₂. While a preferred use of NO₂ as an attractant enhancer is in conjunction with CO₂, NO₂ may also be used to enhance other attractants, alone or in combination, such as Octenol, thermal or light lures, or any other insect attractant known in the art. There are several preferred embodiments of the apparatus of the present invention. In one embodiment, NO₂ is produced by a device that generates the gas through electrical means, such as through an ozone-generator device. The NO₂ generator of this embodiment may be employed alone or in combination with a supplemental source of CO₂ or other attractant supplied from bottles or generated. In another embodiment of the present invention, a mix of NO₂ and CO₂ from bottles, with or without other attractants, is provided for use in a trap designed for use with pressurized gas canisters. In yet another embodiment of the present invention, an NO₂ generator or a small bottle of NO₂ is retrofitted to a CO₂-generating propane mosquito trap, with or without other attractants.

In one embodiment, the invention can employ any suitable ozone-generating device to produce an insect-attracting gaseous product that includes nitrogen dioxide, such as the device disclosed in co-pending U.S. patent application Ser. No. 10/723,421, filed Nov. 26, 2003, and herein incorporated by reference. An advantage of this embodiment over one requiring a gas or propane canister is that it provides a source of insect-attracting gas containing NO₂ that does not require frequent monitoring and/or replacement, as is required for sources of propane, CO₂, pheromones, and/or other attractants in a canister. This is particularly useful with respect to nitrogen dioxide, about which there may be environmental and/or safety concerns when provided in a pressurized state. In an alternate embodiment, the ozone-generating device of this embodiment is employed to provide the NO₂ in combination with a supplemental source of CO₂, which is supplied by any mechanism known in the art, such as by supply from a pressurized canister or by generation from propane.

Ozone generators, whether corona wire or UV, tear apart molecular oxygen and nitrogen from the atmosphere and make a soup of atomic oxygen and nitrogen that are free to combine to form O₂, O₃, N₂, NOₓ, etc. There are many oxides of nitrogen, but only NO and NO₂ are stable in atmosphere. NO is stable for only about 50 minutes, after which it oxidizes into NO₂. As atmospheric air flows through the ozone generator, ozone (O₃) and other gasses, such as nitrogen dioxide, are therefore continuously produced. The ozone-generating device of this embodiment is typically equipped with a source of activated carbon, such as by either placing the source of activated carbon in the ozone generator device or in fluid communication with the ozone generator so that the ozone produced by the generator is caused to flow through the activated carbon. As the ozone and other gases flow through the activated carbon, the ozone is converted into diatomic oxygen (O₂) and carbon dioxide. A gram of activated carbon has hundreds of square meters of surface area. The atomic soup enters the microfissures of the activated carbon and reacts with itself. By passing the atomic soup through activated carbon, some reactions are therefore allowed to proceed to completion because the atomic soup is confined for a time. During this process, O₃ becomes O₂, or reacts with NO to become NO₂, etc. Removing the generated O₃ by this method is useful, because it appears to be a repellent. As an added bonus, any hydrocarbons from the atmosphere that happen to be captured by the activated carbon react with the O₃ to form CO₂ and H₂O, improving the overall attractiveness to mosquitoes of the generated gas. For this reason, CO₂ production by the ozone-generator device peaks as soon as the ozone generator is turned on and then falls off within 20 or 30 minutes. During the peak CO₂ production, hydrocarbon contaminates in the activated carbon are being burned off. When they are gone, the device produces much less CO₂. Passing ozone through the activated carbon therefore allows time to for the conversion of O₃ into O₂, NO₂, and CO₂. The O₂, carbon dioxide, and other gasses, if present, then are caused to pass, such as by a fan, suction pump, by convection or by any other suitable apparatus or means, into any suitable insect attracting and/or destroying trap or apparatus where the insect-attracting gaseous product is employed with any other physical and chemical attractants to attract the insects to an entrapment device.

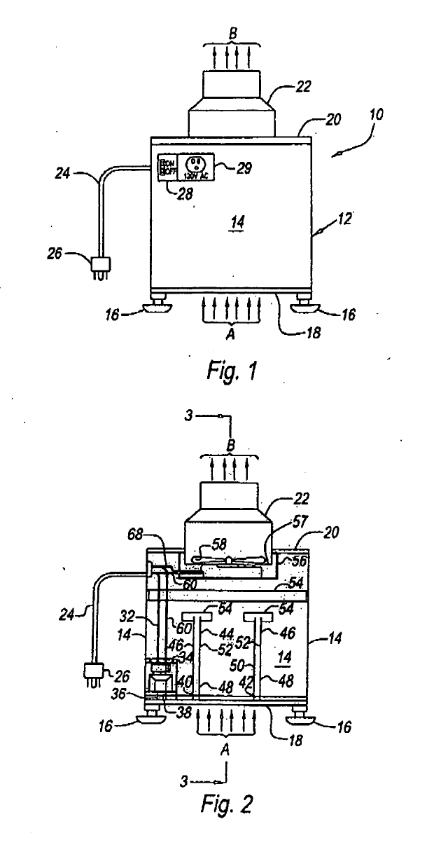

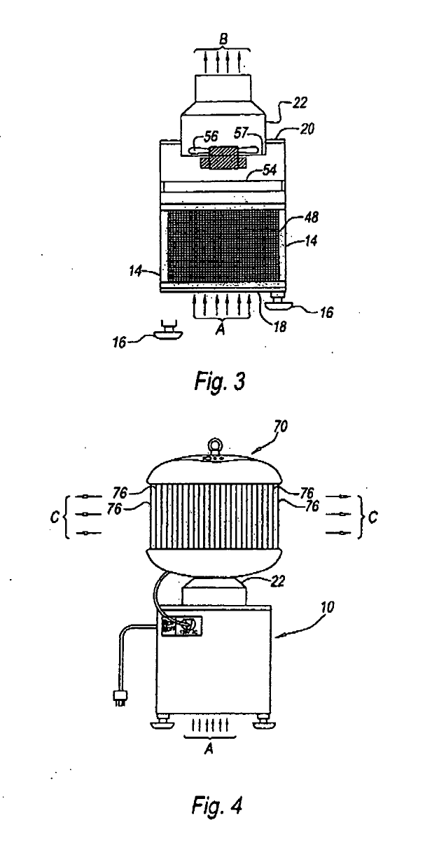

In FIGS. 1 to 3 there is shown an illustrative ozone generator equipped with an activated carbon source for providing an insect-attracting gaseous product containing NO₂ in accordance with this invention for use with an insect entrapment device. The ozone generator can be any suitable device for generating ozone from air, such as for example, UV light generators and corona discharge generators. In a UV light generator, a plasma tube, such as a mercury plasma tube, is used to generate UV light of wavelengths sufficient to dissociate diatomic oxygen in air into atomic oxygen that then combines with other diatomic oxygen in the air being drawn or forced into the generator to form ozone. Such an UV ozone generator is available from Prozone, Inc. of Huntsville, Ala. In a corona discharge ozone generator the ozone is generated by a surface discharge phenomenon between a high-voltage electrode and a low-voltage electrode, which phenomenon is used to ionize air being drawn or forced through the device and between the two electrodes. Such an ozone generator is available from Air-Zone Inc. of Hampton, Va. Among such suitable corona discharge ozone generators available from Air-Zone are their models Air-Zone XT-400 and XT-800. FIGS. 1 to 3 illustrate the invention with a corona discharge ozone generator. Any suitable source of activated carbon, in any suitable shape or form, can be utilized in the process and apparatus of this invention. As an example of suitable activated carbon there may be mentioned an activated carbon mesh pane of the type use as filters, e.g., Honeywell, Inc.'s Activated Carbon Prefilter # 38002.

In FIGS. 1 to 3 there is illustrated an ozone generator 10 modified to produce an output of an insect-attracting gaseous product according to the present invention. The ozone generator 10 comprises a housing 12 of any suitable shape, the shape being shown as rectangular in FIGS. 1 to 3. The housing 12 comprises four joined side panels 14. The housing 12 is provided with leg supports 16, preferably at or near the four corners of the housing, to provide a space for a flow of air, indicated by arrows A, to be drawn or forced into and through the housing. The housing 12 generally has an open-grated bottom panel or panel with vents 18 to permit flow of the air into the generator housing. The top of the housing 12 is provided with a cover panel 20 which has a vent or discharge element 22 projecting generally perpendicularly from the cover panel for providing means to discharge the gaseous products of the generator, as indicated by arrows B. The vent element is preferably a tapered conduit.

In the embodiment illustrated, the generator 10 is provided with an electrical lead 24 and plug 26 for connecting the device to a suitable outlet of an electrical power source (not shown). The device could, however, be powered by a battery unit as the electrical power source. An off/on switch 28 is provided on the housing 10 for activating or deactivating the electrical power source. The generator unit 10 can also be provided with plug receptacle 29 for providing electrical power for a purpose to be explained later. Electrical leads 30 and 32 are provided for connecting the electrical power to a transformer 34 in the housing 10. Transformer 34 outputs suitable voltage/current via electrical leads 36, 38, 40 and 42 to electrodes 44 and 46 located in the lower portion of the housing proximate the open-grated bottom panel 18. Each electrode comprises two metal screen grids 48 and 50, separated by a ceramic core 52 held together by an insulating cap 54. In housing 10, between the electrodes 44 and 46 and the vent 22, there is located an activated carbon element 54, such as a Honeywell, Inc. Activated Carbon Prefilter # 38002, positioned so that air or oxygen that has been subjected to corona discharge from the electrodes 44 and 46 has to pass through the activated carbon element to reach the vent. A support element 56 attached to cover 20 supports a fan 58 located in the entrance 57 of vent 22. Fan 58 is electrically connected to the power source by electrical leads 60 and 62 and operates to draw air A into housing 10 through open grated bottom panel 18 and force gaseous products B out vent 22. If desired, the generator 10 may be provided with a remote control and means activated by the remote control for operating the unit, such as for example, to turn the unit off or on.

When electrical power is provided to the generator unit 10 and the unit is turned on via switch 28, fan 56 draws air A into the unit where the air passes through the corona discharge provided by electrode elements 44 and 46 and ozone and other gasses, such nitrogen dioxide, is produced. The ozone and other gasses are then forced by fan 56 to be drawn into contact with the activated carbon 54 where ozone is reacted with other molecules to form nitrogen dioxide, carbon dioxide, and diatomic oxygen. The activated carbon serves to remove the ozone from the system. The nitrogen dioxide, carbon dioxide, diatomic oxygen, and any other gasses are then forced by the fan 56 to exit the housing 10 through vent 22, thereby providing an insect-attracting gaseous product containing nitrogen dioxide.

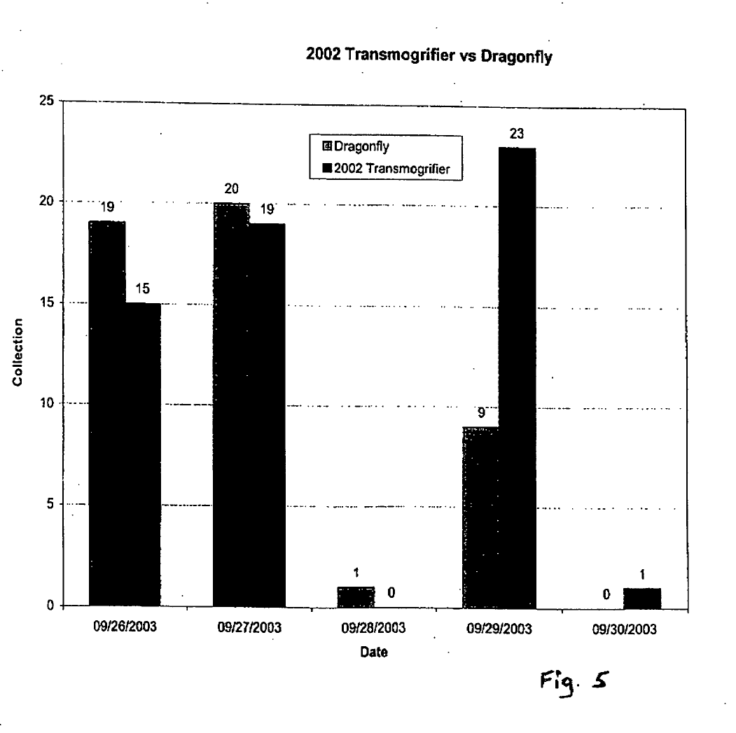

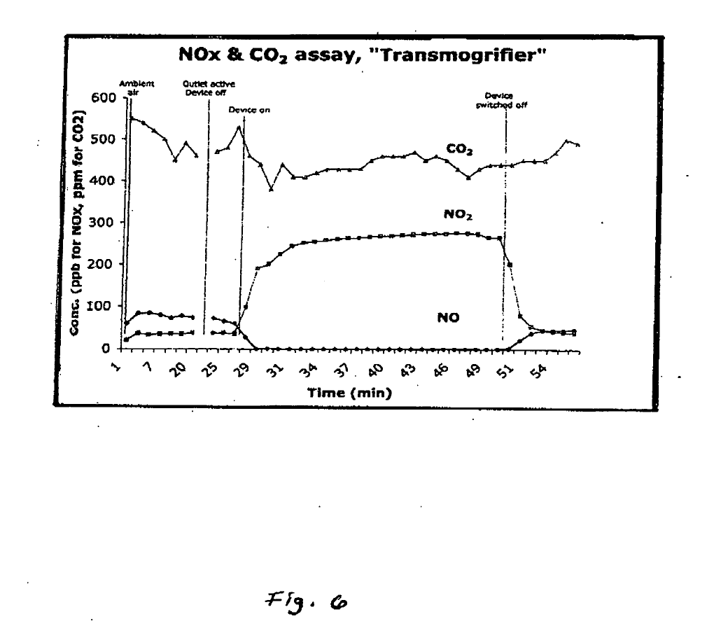

In FIG. 4, the generator unit 10, as depicted in FIGS. 1 to 3, has an insect attracting/destroying trap unit 70, (such as one of the type disclosed in U.S. Pat. No. 6,055,766, the disclosure of which is incorporated by reference herein) mounted over vent 22 so as to receive the gaseous products B. If the insect trap 70 is of such a nature as to require or need electrical power it can be provided with an electrical lead 72 having a plug 74 for plugging into electrical outlet 29 on housing 10. For example, the trap 70 may have an electrical grid (not shown) inside the trap for destroying insects attracted to the trap and electrical lead 72 may be used to power that grid. The gases B from generator unit 10 are forced by fan 56 (FIGS. 1 to 3) to flow through vent 22 into trap 70 and out through vertical supports 76 of the trap as attractant gases identified by arrows C to act as attractants for insects.

It will be appreciated that, although the invention has been illustrated in FIG. 4 by use of a generator unit with an insect trap of the type described in U.S. Pat. No. 6,055,766, any ozone generator unit of this invention may be employed with any suitable or useful insect attracting and/or destroying device. That is, the trap unit may be of any suitable size or shape and may utilize any suitable other insect attractant and/or any suitable insect destroying means. For example, the trap may be one employing any one or more additional attractants, such as for example, heat, light such as near UV and UV light, insect audible sounds such as heartbeat mimicked sounds, natural and synthetic pheromones, and natural and synthetic kairomones. The trap may also employ one or more entrapment/destruction means, such as for example, sticky or adhesive material to trap and confine the insects, a vacuum source to collect the attracted insects, an electrical grid or the like to kill or destroy the attracted insects.

It has been found that the ozone-generator device of this embodiment performs best when the humidity is not unusually high. Humidity appears to inhibit the process employed by the device because it appears to coat the activated carbon, thereby stopping the reaction. As a result, more O₃, less NO₂, and almost no CO₂ are produced. A heater or dryer to drive water from the activated carbon and keep the reaction going is therefore recommended for operation in humid conditions. Silica gel may also be used to absorb humidity from the air entering the device.

The present invention demonstrates that a gaseous mixture of carbon dioxide with nitrogen dioxide acts as an improved attractant compared to carbon dioxide alone. It has been demonstrated in tests that insect attractiveness can be increased 10-fold or more over carbon dioxide alone when the insect-attracting gaseous mixture containing nitrogen dioxide produced by an activated carbon modified ozone generator is employed as the attractant.

For example, three mosquito traps were tested in field trials lasting nine days in October 2002. The test protocol was a 3 by 3 Latin Square in which three commercially available Dragonfly traps manufactured by BioSensory, Inc of Willimantic, Conn. were baited with different attractants. Trap Number 1 was baited with octenol and a pulsed discharge of 250 ml/min CO₂ from a canister, producing CO₂ concentrations of approximately 7000 parts per million at the discharge point. Trap Number 2 was baited with octenol alone. Trap Number 3, referred to as the “Transmogrifier”, was baited with octenol and a preferred embodiment of the insect-attracting gaseous product of this invention in a continuous discharge, the insect-attracting gaseous product of these tests initially containing a CO₂—NOₓ mixture having CO₂ concentrations of approximately 750 parts per million at the discharge point, with the CO₂ concentration of the mixture falling to levels that were indistinguishable from ambient levels within one hour while the NO₂ concentration remained steady. Three test locations were established at mosquito-infested areas near Tweed Airport in East Haven Conn. Each trap was tested at each location overnight. Every day mosquito collections in each trap were removed, identified by species, counted and recorded. Traps were then rotated to the next test location and the test was repeated that night. In order to test each trap at each location, one complete rotation of the protocol required three nights. The test protocol was repeated three times over nine consecutive nights. Data from this field trial appears in Table 1.

TABLE 1

| | | Mosquito Collection | |
|---|---|---|---|
| Trap | | Number of | Total |
| No. | Bait | Species | Individuals |
| 1 | Octenol, 250 ml/min CO₂ | 7 | 263 |
| 2 | Octenol | 4 | 28 |
| 3 | Octenol, insect-attracting | 8 | 118 |
| | gaseous product including NO₂ | | |

Although Trap Number 3 was found to be generating only one-tenth the amount of CO₂ compared to the emissions of Trap Number 1, and these amounts dropped to levels that were indistinguishable from ambient levels within one hour, its collections were equal to 44.8% of the collections of Trap Number 1 and were drawn from a larger number of mosquito species. Compared to Trap Number 2, which had no CO₂ emissions, Trap Number 3 collections were 420% larger and were drawn from twice as many mosquito species.

In another example, in a September 2003 field trial, two mosquito traps were tested in field trials lasting five days. In this trial, two commercially available Dragonfly traps manufactured by BioSensory, Inc were baited with different attractants. A first trap was baited with a pulsed discharge of 180 ml/min CO₂ from a canister, Octenol released at approximately 3.5 mg/hour, and heat from a thermal lure. A second trap, the same “2002 Transmogrifier” used in the October 2002 field trial, was baited with Octenol and an ozone-generator-produced insect-attracting gaseous mixture containing NO₂ in a continuous discharge, the gaseous mixture initially containing a CO₂—NO₂ mixture, with the CO₂ concentration of the mixture falling to levels that were indistinguishable from ambient levels within one hour. Two test locations were established at Thill Street, West Haven, Conn. Each trap was tested at each location overnight. Every day mosquito collections in each trap were removed, identified by species, counted and recorded. Traps were then rotated to the other test location and the test was repeated that night. The test protocol was repeated over five consecutive nights. The results of this field trial are shown graphically in FIG. 5.

In FIG. 5, it can be seen that the Transmogrifier performed as well as, and at times better than, the standard Dragonfly trap baited with CO₂ from a canister and octenol. Although the Transmogrifier generated only one-tenth the amount of CO₂ compared to the emissions of the standard Dragonfly, and these amounts dropped to levels that were indistinguishable from ambient levels within one hour, its total collections over the five nights were 118% of the collections of the Dragonfly trap over the same time period.

The emissions from the “2002 Transmogrifier” trap used in the October 2002 (“Trap Number 3”) and September 2003 field trials were measured in the laboratory in May 2003. Gas concentrations were assayed with a Thermo Environmental Instruments (TEI) 42C—NO—NO₂—Noₓ Analyzer. Results to the nearest 0.1 ppb were displayed digitally and recorded. Gas emanating from the “Transmogrifier” was sampled through one end of a flexible plastic tube affixed just inside the 4-inch diameter exhaust port (and in a quadrant with obvious outward flow), and the gas sample was drawn continuously into the TEI NOₓ Analyzer. The goal was to measure the output of NO and NO₂ from the functioning “Transmogrifier” versus background levels. Sufficient time (3-10+ minutes) was allowed for the readings to stabilize before measurement. Table 2 summarizes the measurements recorded. As can be seen, when the “2002 Transmogrifier” was running with all three plates in place, the concentration of NO corresponded to background, but that of NO₂ was significantly greater than background.

TABLE 2

| | | | | Concentration (ppb) | |
|---|---|---|---|---|---|
| | Power | Unit | Electrode | | |
| Trial | cord | switched | plates | NO | NO₂ |
| Background | N/a | N/a | N/a | 2.7 | 22.0 |
| 2002 | In | On | In | 2 | 281 |
| Transmogrifier | | | | | |

After the September 2003 field trial, in November 2003, laboratory tests were again performed on the 2002 Transmogrifier device. These tests also used the TEI analyzer, and also used a Vaisala handheld CO₂ meter. The analyzer wand was positioned at the exhaust port of the Transmogrifier, and the digital output was recorded at one-minute intervals. Measurements were taken and recorded during intervals when the Transmogrifier device was configured as follows (in order): Electrical Plug Out/Switch Off, Electrical Plug In/Switch Off; Electrical Plug In/Switch On, and Electrical Plug In/Switch Off.

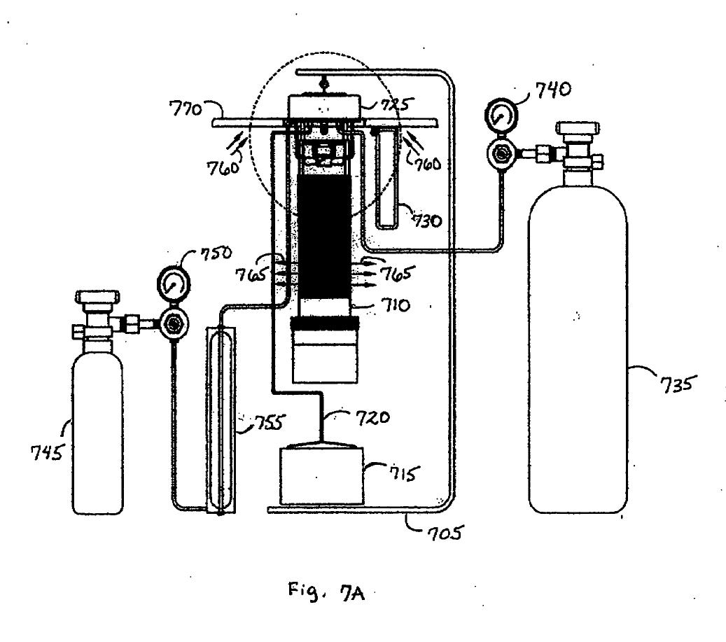

A plot of the tabulated data from this test is shown in FIG. 6. As seen in FIG. 6, while energized the 2002 Transmogrifier produced quantities of NO₂ several orders of magnitude greater than levels in ambient air, produced significantly depressed NO concentrations (trace amounts at best), and did not affect ambient concentrations of CO₂. These results confirmed the results from the May 2003 laboratory test that showed that the insect-attracting gaseous product being generated by the Transmogrifier device field tested in October 2002 and again in September 2003 contained large amounts of nitrogen dioxide and none to only trace amounts of other nitrous compounds.

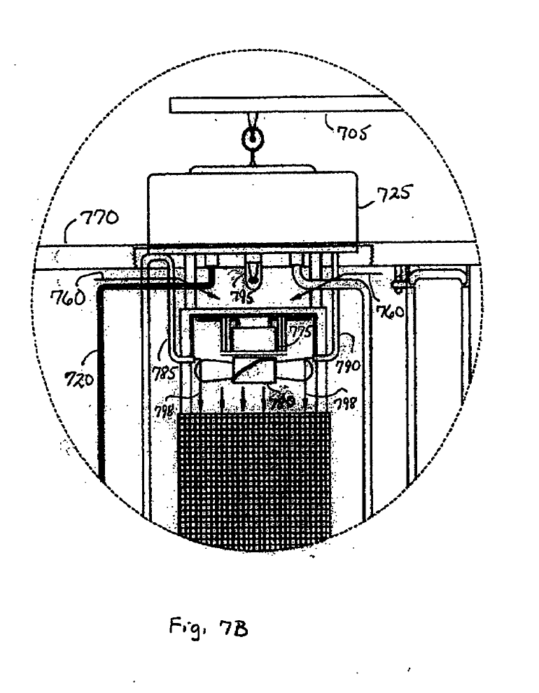

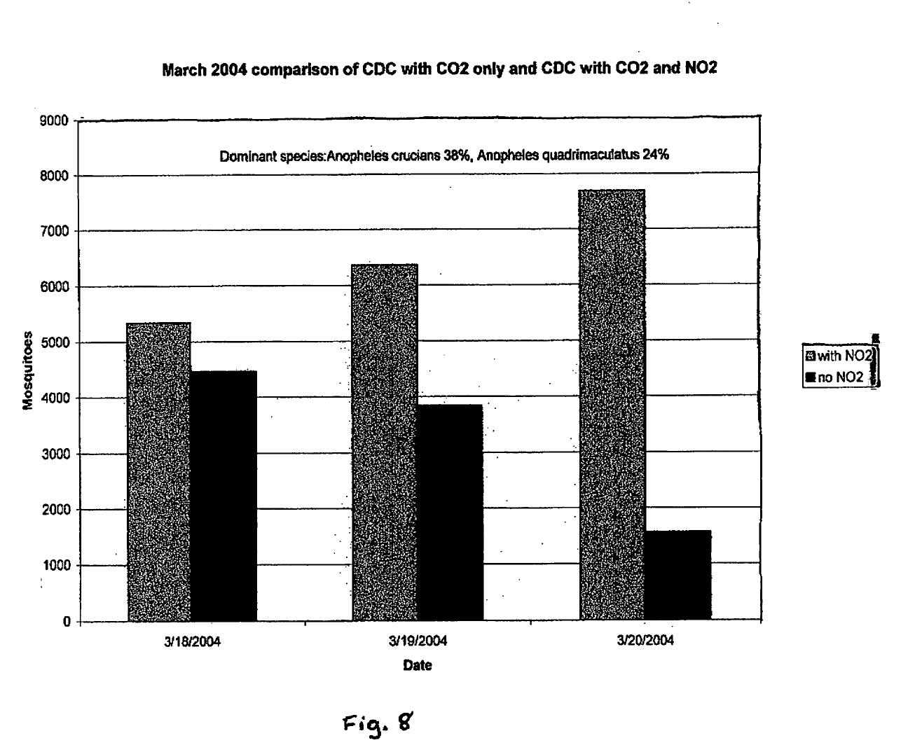

In another embodiment of the present invention, a mix of CO₂ and NO₂ from bottles is provided for use in a trap designed for use with pressurized gas canisters. FIGS. 7A and 7B depict a preferred embodiment of an insect trap that uses NO₂ from a canister to enhance the attractiveness of CO₂, Octenol, and light lures. As shown in FIG. 7A, stand 705 supports a standard CDC-type trap comprising collection bag 710, preferably made of a porous, screen-like material, 6V battery 715, power leads 720, and circuit board cover 725, which covers the electronic circuitry for the trap. The trap is baited with optional Octenol lure 730 and CO₂ provided from canister 735 via regulator 740. The trap is also baited with an NO₂/air mixture provided from secondary canister 745 via regulator 750 and measured by gas flowmeter 755. The direction of air flow into and out of the trap is depicted by arrows 760 and 765, respectively. Cover brim 770 is disposed below circuit board cover 725 and assists in directing air flow into the trap. As shown in FIG. 7B, the trap of this embodiment also has 6V DC motor 775, powered by battery 715, for running fan 780. The NO2/air mixture from secondary canister 745 is discharged into the trap via NO2/air discharge 785 and the CO₂ from canister 735 is discharged into the trap via CO₂ discharge 790. In one embodiment, the trap also includes optional ¼ Amp (1.5 Watt) incandescent light bulb 795, also powered by battery 715, to act as an additional lure. The direction of air flow into the trap and through fan 775 is depicted in FIG. 7B by arrows 760 and 798, respectively. While the embodiment depicted shows CO₂, Octenol, and light lures, it should be clear to one of ordinary skill in the art that any subset or combination of these lures may be used in the present invention and that any other chemical or mechanical lure known in the art could also be employed, either alone or in combination with any of the foregoing.

During trap operation, CO₂ is discharged into the trap at CO₂ discharge 790 from canister 735 and the NO₂/air mixture is discharged into the trap at NO₂/air discharge 785 from secondary canister 745. Insects are attracted to the trap by the combined gas lures and/or the combination of the Octenol 730 and/or light lure 795 with the NO₂/gas mixture. Battery 715 powers motor 775 via power leads 720 to run fan 780. The movement of fan 780 causes air to flow into 760 the trap at the top, through 798 the fan area, and out 765 at a screened area at the bottom of the collection bag. Insects attracted to the trap by the lures are thereby pulled into the trap and down into collection bag 710. While the embodiment depicted shows a particular trap configuration, it should be clear to one of ordinary skill in the art that any subset or combination of the elements shown, any other elements known in the art for use in insect traps, or any other suitable insect trap or killing device known in the art and adapted or adaptable for use with pressurized gas canisters may be used in the present invention. In particular, the present invention may employ other types of power sources, such as a rectified or AC power source, and may also advantageously employ photocells or timers in order to control the times of release of the NO₂ and other gasses, thereby conserving them by limiting gas release to those times of day when mosquitoes are particularly problematic.

This embodiment of the invention was demonstrated in, for example, a field trial performed in March of 2004. In this trial, two mosquito traps were tested over three days. The test protocol was a 4 by 4 Latin Square with two replicates in which two CDC traps were baited with different attractants. The CDC traps utilized for this trial were standard battery-powered fan traps that emit gas from pressurized canisters. The trap baited with NO₂ was constructed in accordance with the embodiment of FIGS. 7A and 7B. Four test locations were established at Loxahatchee National Wildlife Refuge in Florida (LNWR). Each trap was tested at each location overnight. Every day mosquito collections in each trap were removed, identified by species, counted and recorded. Traps were then rotated to the next test location and the test was repeated that night. Both traps were baited with CO₂ and an Octenol lure, with the second trap also baited with dilute NO₂ from the secondary tank. Both traps were set to deliver 250 ml/min CO₂. The secondary NO₂ tank mix was 5000 ppb NO₂, with the rest being air. This is roughly than 20 times greater than the NO₂ emissions of the 2002 Transmogrifier described previously, which were 200 to 300 ppb at the release point. An NO₂ gauge reading of 20 equals delivery of 4.78 cc/min, so the rate of NO₂ release was 0.000024 cc/min at the release point.

The results of this field trial are summarized in Table 3 and depicted graphically in FIG. 8. In Table 3, it is shown that a greatly increased attraction level was observed from the combination of nitrogen dioxide with carbon dioxide as compared to the attraction level of carbon dioxide alone. In particular, the collections of the CDC trap baited with both CO₂ and NO₂ had total collections equal to 164% of the collections of the CDC trap baited with CO₂ alone. This trial clearly demonstrates the effectiveness of one aspect of the present invention, wherein NO₂ is employed as an enhancing agent for a known insect-attracting gas. As seen in FIG. 8, the CDC/CO₂, NO₂ trap had greater collections than the CDC trap baited with CO₂ alone. The results make clear the attractant-enhancing effect of NO₂ according to this aspect of the present invention.

TABLE 3

Mosquito Collection

| Trap/Bait | Number of Species | Total Individuals |
|---|---|---|
| CDC/CO₂ | 8 | 12,036 |
| CDC/CO₂, NO₂ | 9 | 19,752 |

The present invention demonstrates, therefore, that the inclusion of very small amounts of NO₂, at a discharge rate on the order of 0.2 cc/min or less, enhances the effectiveness of CO₂ or other attractants as much as ten-fold. One of the primary advantages of this invention is that it permits use of greatly reduced levels of the other attractants, thereby greatly increasing the intervals between necessary replenishment of those attractants in a trap and concomitantly decreasing the costs associated with the purchase and replenishment of those attractants. It should be noted that care should be taken to ensure that the NO₂ levels supplied are not overly large, as data suggests that very high levels may repel, rather than attract, mosquitoes. Note that the NIOSH (National Institute for Occupational Safety and Health) IDLH (Immediately Dangerous to Life or Health) concentration for NO₂ is 20 ppm (20,000 ppb). As a practical limit, OSHA currently specifies a Permissible Exposure Limit (PEL) for NO₂ of 5 ppm (5000 ppb), which level has been shown by these tests to be very attractive to mosquitoes.

In yet another embodiment of the present invention, an NO₂ generator or a small bottle of NO₂ is retrofitted to a CO₂-generating propane mosquito trap. In this embodiment, the ozone-generator device described in conjunction with FIGS. 1-4, or any other suitable device for generation of NO2 through electrical means, or a secondary canister containing an NO2 mixture, such as described in conjunction with FIGS. 7A and 7B, is retrofitted to a propane mosquito trap, such as the commercially available SkeeterVac Model 35 produced by Blue Rhino Consumer Products LLC of Winston-Salem, N.C. or the Mosquito Deleto 2500 Active System produced by The Coleman Companies of Wichita, Kans., using standard techniques known in the art.

While the preferred embodiment of the present invention employs NO₂ as an attractant enhancer, it has also been shown that NO₂ alone acts as an attractant for at least some species. In particular, it appears that more primitive species found around fresh-water lakes, such as Mansonia dyari and Coquillettidia perturbans, are attracted equally to NO₂ and CO₂. It is speculated that perhaps these more primitive mosquito species have more generalized receptors that cannot differentiate NO₂ from CO₂.

This embodiment of the invention was demonstrated in, for example, a Mesozoic Landscape trial performed in December 2003 in Lantana, Fla. In this trial, four mosquito traps were tested over 5 days. The test protocol was a 4 by 4 Latin Square with two replicates in which two standard CDC traps were baited with CO₂ and an Octenol lure. The CDC traps utilized for this trial were standard battery-powered fan traps that emit gas from pressurized canisters. The other two traps were the 2002 Transmogrifier shown in FIGS. 1-4 and a “vacuum Transmogrifier” that was a replica of the 2002 Transmogrifier with a vacuum capture mechanism. Both Transmogrifier traps produced 200-300 ppb NO₂. Four test locations were established and each trap was tested at each location overnight. Every day mosquito collections in each trap were removed, identified by species, counted and recorded. Traps were then rotated to the next test location and the test was repeated that night.

The results of this field trial are summarized in Table 4. In Table 4, it can be seen that, while all the traps tested captured mosquitoes, Mansonia dyari represented a much higher percentage of the collections of the two Transmogrifier traps baited with NO₂ than of the collections of the two CO₂-baited CDC traps.

TABLE 4

| | Mosquito Collection | | |
|---|---|---|---|
| | Total | | |
| | Individ- | Total Mn. | % Mn. |
| Trap/Bait | uals | dyari | dyari |
| CDC/CO₂, Octenol #1 | 2941 | 1068 | 36.31 |
| Vacuum Transmogrifier/NO₂, Octenol | 533 | 379 | 71.11 |
| CDC/CO₂, Octenol #2 | 2568 | 945 | 36.80 |
| Original Transmogrifier/NO₂, Octenol | 167 | 91 | 54.50 |

The present invention therefore provides methods and apparatus for insect attraction through the use of nitrogen dioxide. Nitrogen dioxide is used both for insect attraction and to enhance the effectiveness of other insect-attracting gasses. While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

What is claimed is:

1. A method for attracting insects to a desired area or apparatus, the method comprising the step of supplying a gaseous insect-attracting product containing at least nitrogen dioxide to the area or apparatus.

2. The method of claim 1, wherein the gaseous insect-attracting product also contains at least carbon dioxide.

3. The method of claim 1, wherein the desired apparatus is an insect trap.

4. The method of claim 2, wherein the desired apparatus is an insect trap.

5. The method of claim 3, wherein the nitrogen dioxide is supplied from a canister.

6. The method of claim 3, further comprising the step of generating the supplied nitrogen dioxide from the atmosphere by an electrical device.

7. The method of claim 6, the step of generating the supplied nitrogen dioxide further comprising the steps of
passing at least atmospheric air through an ozone producing unit to produce a gaseous product containing at least ozone and nitrogen; and
passing the gaseous product containing at least ozone and nitrogen through activated carbon to produce an insect-attracting gaseous product containing at least nitrogen dioxide.

8. The method of claim 4, wherein the nitrogen dioxide is supplied from a canister.

9. The method of claim 4, further comprising the step of generating the supplied nitrogen dioxide from the atmosphere by an electrical device.

10. The method of claim 9, the step of generating the supplied nitrogen dioxide further comprising the steps of
passing at least atmospheric air through an ozone producing unit to produce a gaseous product containing at least ozone and nitrogen; and
passing the gaseous product containing at least ozone and nitrogen through activated carbon to produce an insect-attracting gaseous product containing at least nitrogen dioxide.

11. The method of claim 3, wherein the insect trap to which the insect-attracting gaseous product containing at least nitrogen dioxide is provided also contains elements for retaining and optionally destroying insects attracted to the trap.

12. The method of claim 4, wherein the insect trap to which the insect-attracting gaseous product containing at least nitrogen dioxide is provided also contains elements for retaining and optionally destroying insects attracted to the trap.

13. The method of claim 4, wherein the carbon dioxide is supplied from a canister.

14. The method of claim 4, wherein the carbon dioxide is generated from propane.

15. A method for attracting insects to a desired area or apparatus by using nitrogen dioxide as an insect-attractant enhancer, comprising the steps of:
supplying at least one insect attractant to the area or apparatus; and
concurrently supplying nitrogen dioxide to the area or apparatus.

16. The method of claim 15, wherein the insect attractant contains at least carbon dioxide.

17. The method of claim 15, wherein the apparatus is an insect trap.

18. The method of claim 16, wherein the apparatus is an insect trap.

19. The method of claim 17, wherein the nitrogen dioxide is supplied from a canister.

20. The method of claim 17, further comprising the step of generating the supplied nitrogen dioxide from the atmosphere by an electrical device.

21. The method of claim 20, the step of generating the supplied nitrogen dioxide further comprising the steps of:
passing at least atmospheric air through an ozone producing unit to produce a gaseous product containing at least ozone and nitrogen; and
passing the gaseous product containing at least ozone and nitrogen through activated carbon to produce an insect-attracting gaseous product containing at least nitrogen dioxide.

22. The method of claim 18, wherein the nitrogen dioxide is supplied from a canister.

23. The method of claim 18, further comprising the step of generating the supplied nitrogen dioxide from the atmosphere by an electrical device.

24. The method of claim 23, the step of generating the supplied nitrogen dioxide further comprising the steps of:
passing at least atmospheric air through an ozone producing unit to produce a gaseous product containing at least ozone and nitrogen; and
passing the gaseous product containing at least ozone and nitrogen through activated carbon to produce an insect-attracting gaseous product containing at least nitrogen dioxide.

25. The method of claim 17, wherein the insect trap to which the insect-attracting gaseous product is provided also contains elements for retaining and optionally destroying insects attracted to the trap.

26. The method of claim 18, wherein the insect trap to which the insect-attracting gaseous product is provided also contains elements for retaining and optionally destroying insects attracted to the trap.

27. The method of claim 18, wherein the carbon dioxide is supplied from a canister.

28. The method of claim 18, wherein the carbon dioxide is generated from propane.

29. An apparatus for providing an insect-attracting gaseous product containing at least nitrogen dioxide to an insect trap comprising:
a source of nitrogen dioxide; and
an insect trap, the trap being positioned with respect to the source of nitrogen dioxide in such a manner that insects attracted to the source of nitrogen dioxide are collected by the insect trap.

30. The apparatus of claim 29, wherein the source of nitrogen dioxide is a device that generates nitrogen dioxide from the atmosphere.

31. The apparatus of claim 31, wherein the device that generates nitrogen dioxide from the atmosphere comprises:
an ozone-producing unit provided with activated carbon, the activated carbon being positioned so as to be in contact with ozone produced by the unit, the unit being in fluid communication with the insect trap for providing the nitrogen dioxide to the insect trap.

32. The apparatus of claim 30, further comprising a source of at least one other insect attractant.

33. The apparatus of claim 32, wherein the other insect attractant comprises at least carbon dioxide.

34. The apparatus of claim 33, wherein the source of carbon dioxide is a canister.

35. The apparatus of claim 33, wherein the source of carbon dioxide is a device that generates carbon dioxide from propane.

36. The apparatus of claim 29, wherein the source of nitrogen dioxide is a canister.

37. The apparatus of claim 36, further comprising a source of at least one other insect attractant.

38. The apparatus of claim 37, wherein the other insect attractant comprises at least carbon dioxide.

39. The apparatus of claim 38, wherein the source of carbon dioxide is a canister.

40. The apparatus of claim 38, wherein the source of carbon dioxide is a device that generates carbon dioxide from propane.
